(19) United States
(12) Patent Application Publication
(10) Pub. No.: US 2026/0059462 A1
(43) Pub. Date: Feb. 26, 2026

(54) MULTIPLE TAG MAPPING

(71) Applicant: QUALCOMM Incorporated, San Diego, CA (US)

(72) Inventors: Fang YUAN, Beijing (CN); Yan ZHOU, San Diego, CA (US); Jelena DAMNJANOVIC, Del Mar, CA (US); Tao LUO, San Diego, CA (US)

(21) Appl. No.: 19/101,234

(22) PCT Filed: Sep. 30, 2022
(86) PCT No.: PCT/CN2022/123045

§ 371 Date: Feb. 4, 2025

(51) Int. Cl. H04W 56/00

(52) U.S. Cl. CPC H04W 56/0045; H04W 56/001

(57) ABSTRACT

Apparatus, methods, and computer program products for wireless communication are provided. An example method may include transmitting, to a second network entity, capability information indicative of at least one quantity of timing advance groups (TAGs) supported by the first network entity. The example method may further include receiving, from the second network entity, a configuration of a set of TAGs based on the capability information.

### TECHNICAL FIELD

The present disclosure relates generally to communication systems, and more particularly, to wireless communication systems with timing advance groups (TAGs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a first network entity (such as a user equipment (UE)) are provided. The apparatus may include a memory and at least one processor coupled to the memory. The at least one processor may be configured to transmit, to a second network entity, capability information indicative of at least one quantity of timing advance groups (TAGs) supported by the first network entity. The at least one processor may be configured to receive, from the second network entity, a configuration of a set of TAGs based on the capability information. The at least one processor may be configured to receive, from a second network entity, a configuration of a set of TAGs. The at least one processor may be configured to receive an activation of a subset of TAGs of the set of TAGs via a medium access control (MAC) control element (MAC-CE) or downlink control information (DCI), where the MAC-CE or the DCI is associated with one or more codepoints, where each codepoint of the one or more codepoints is mapped to a respective TAG identifier (ID) associated with a respective TAG of the subset of TAGs according to a mapping. The at least one processor may be configured to communicate with the second network entity based on the subset of TAGs. The at least one processor may be configured to receive, from a second network entity, a configuration of a set of TAGs, where the set of TAGs includes a primary TAG associated with a primary cell, and where a TAG ID associated with the primary TAG is zero. The at least one processor may be configured to receive an activation of a subset of TAGs of the set of TAGs via a MAC-CE or DCI. The at least one processor may be configured to communicate with the second network entity based on the subset of TAGs.

In another aspect of the disclosure, a method, a computer-readable medium, and an apparatus at a first network entity (such as a base station) are provided. The apparatus may include a memory and at least one processor coupled to the memory. The at least one processor may be configured to receive, capability information indicative of at least one quantity of TAGs supported by a second network entity. The at least one processor may be configured to transmit a configuration of a set of TAGs based on the capability information. The at least one processor may be configured to transmit, for a second network entity, a configuration of a set of TAGs. The at least one processor may be configured to transmit an activation of a subset of TAGs of the set of TAGs via a MAC-CE or DCI, where the MAC-CE or the DCI is associated with one or more codepoints, where each codepoint of the one or more codepoints is mapped to a respective TAG ID associated with a respective TAG of the subset of TAGs according to a mapping. The at least one processor may be configured to communicate with the second network entity based on the subset of TAGs. The at least one processor may be configured to transmit a configuration of a set of TAGs, where the set of TAGs includes a primary TAG associated with a primary cell, and where a TAG ID associated with the primary TAG is zero. The at least one processor may be configured to transmit an activation of a subset of TAGs of the set of TAGs via a MAC-CE or DCI. The at least one processor may be configured to communicate with a second network entity based on the subset of TAGs.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRA WINGS

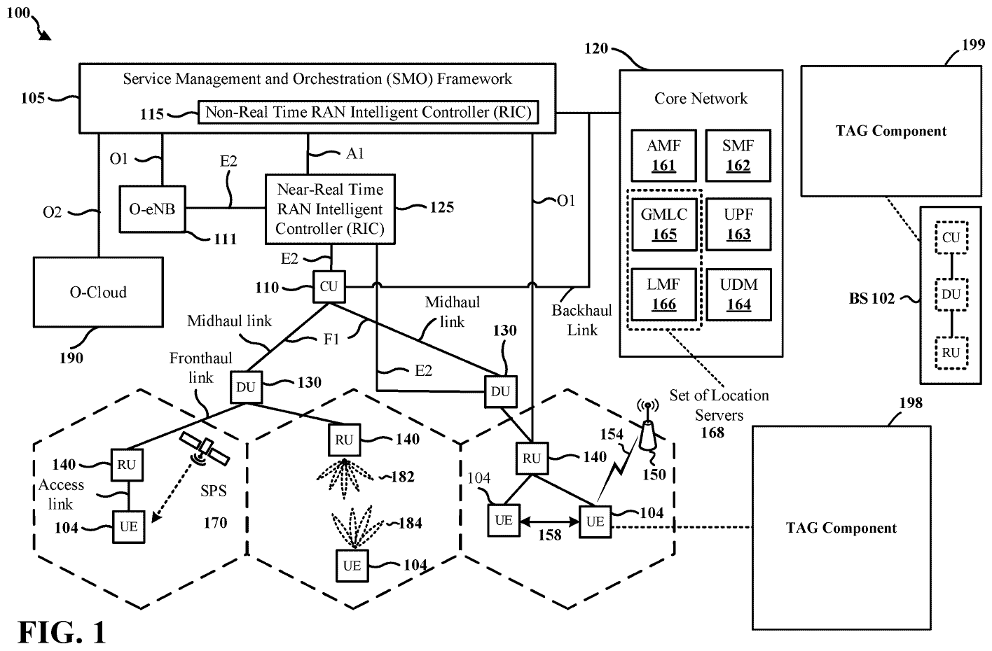

FIG. 1 is a diagram illustrating an example of a wireless communications system and an access network.

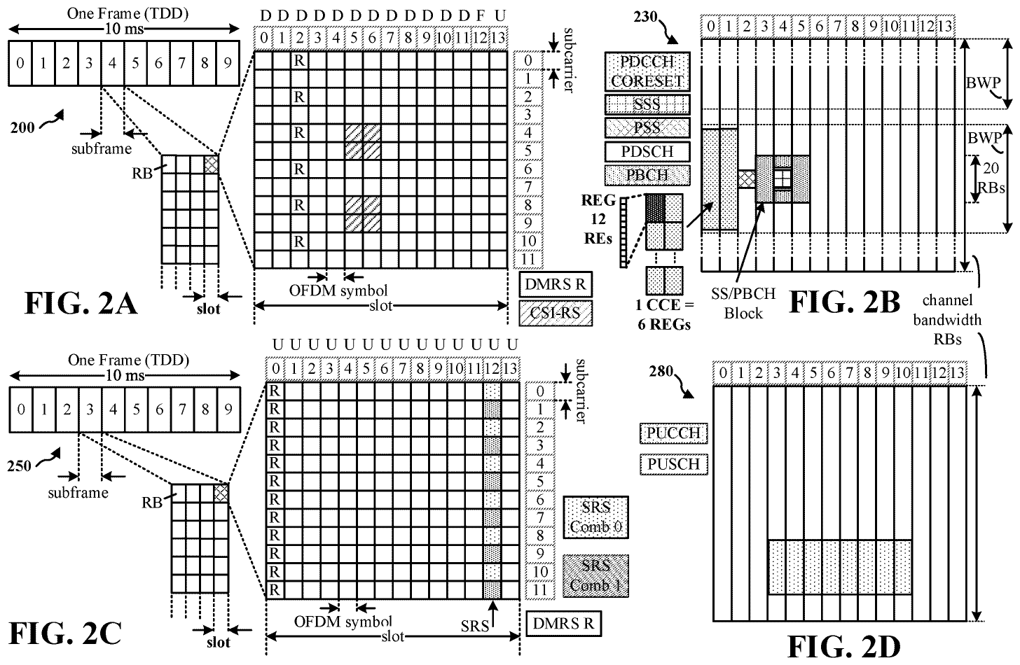

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

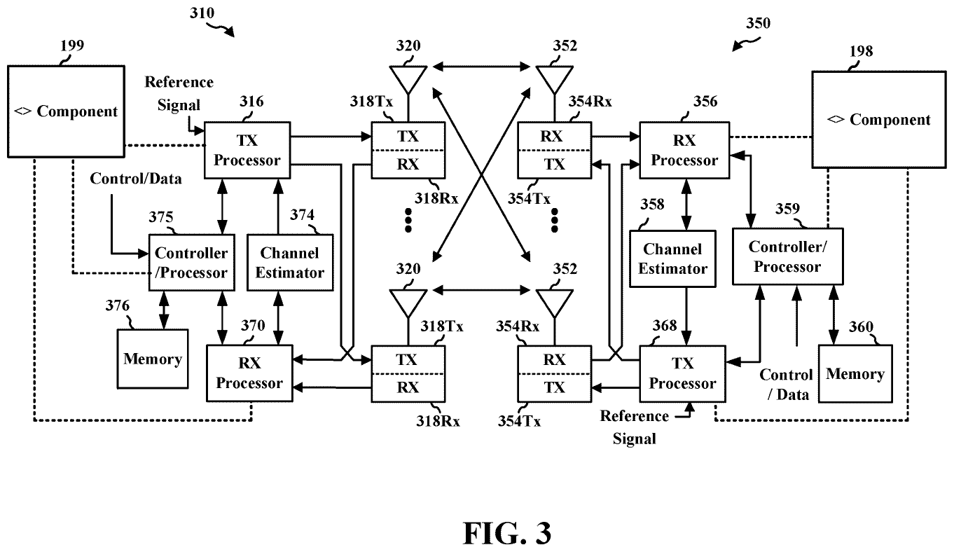

FIG. 3 is a diagram illustrating an example of a base station and user equipment (UE) in an access network.

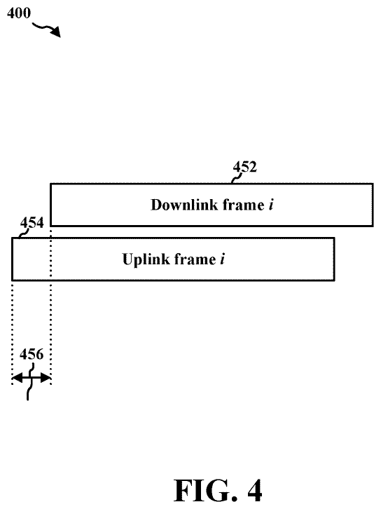

FIG. 4 is a diagram illustrating an example timing advance (TA).

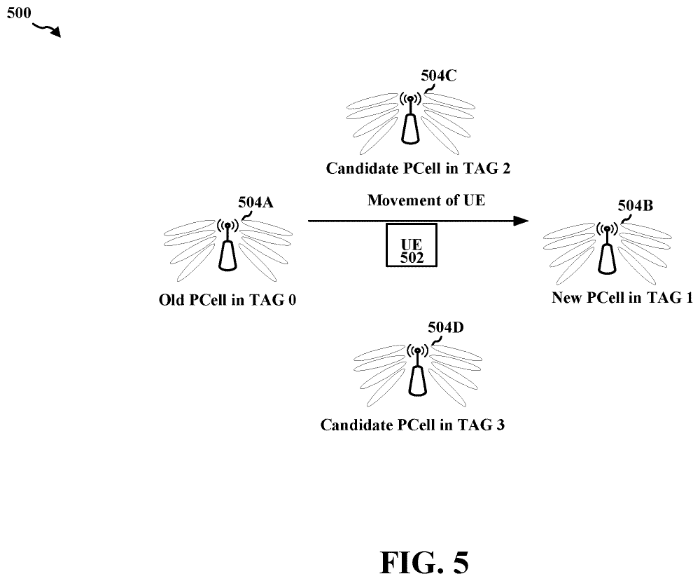

FIG. 5 is a diagram illustrating an example of movement of UE and associated switching of primary cell (PCell).

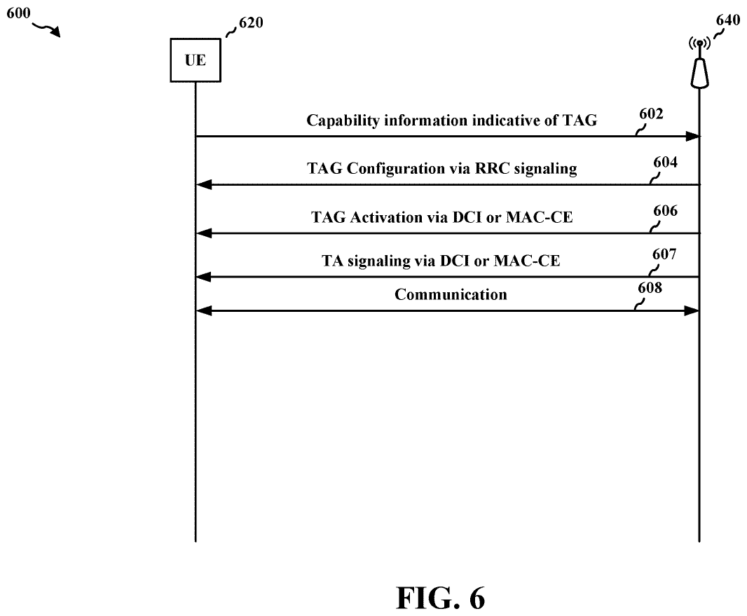

FIG. 6 is a diagram illustrating example communications between a network entity and a UE.

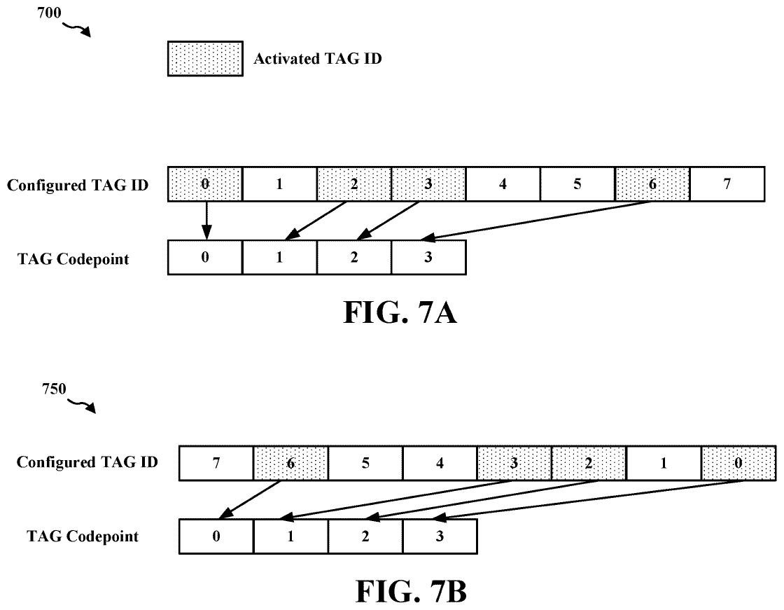

FIG. 7A is a diagram illustrating an example mapping of TAG ID and TAG code points.

FIG. 7B is a diagram illustrating an example mapping of TAG ID and TAG codepoints.

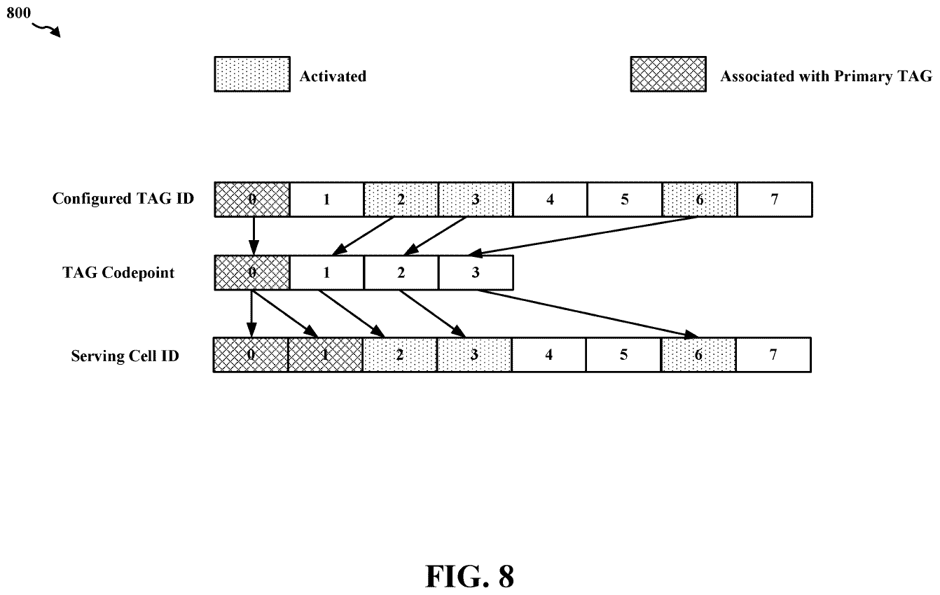

FIG. 8 is a diagram illustrating an example mapping of TAG ID, TAG codepoints, and serving cell ID.

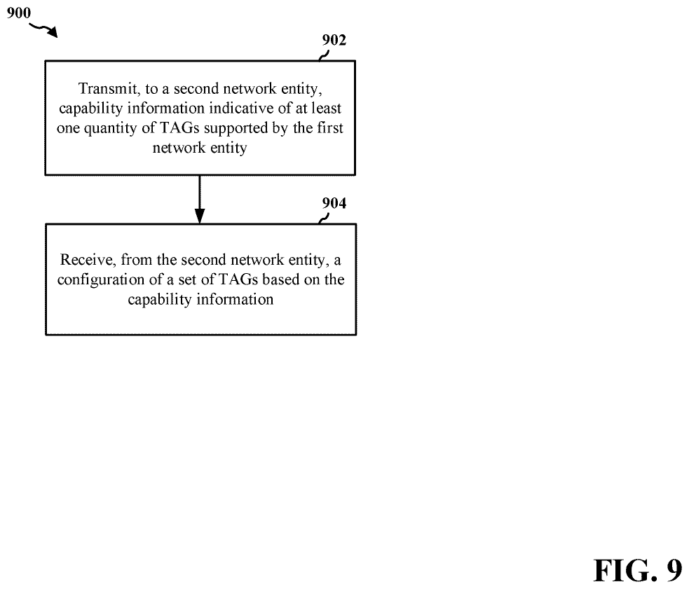

FIG. 9 is a flowchart of a method of wireless communication.

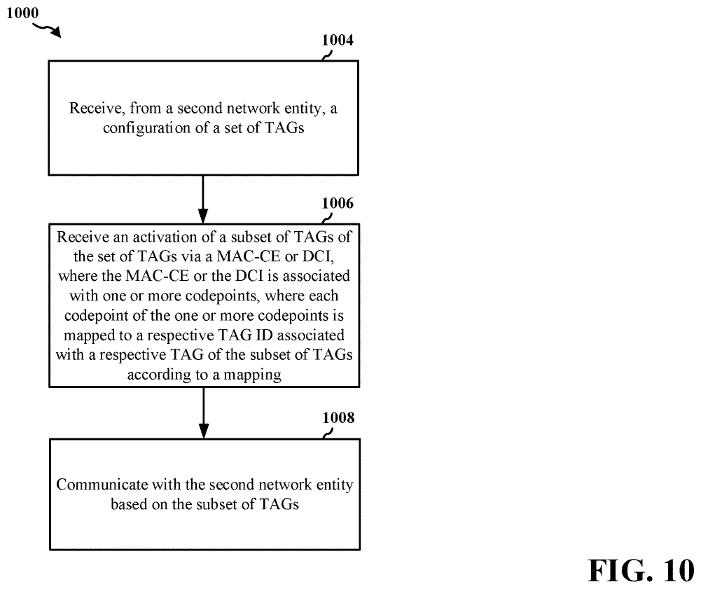

FIG. 10 is a flowchart of a method of wireless communication.

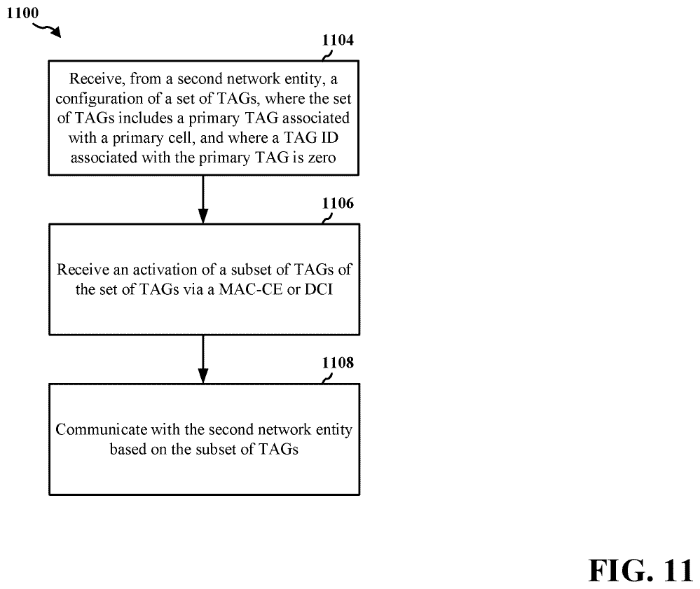

FIG. 11 is a flowchart of a method of wireless communication.

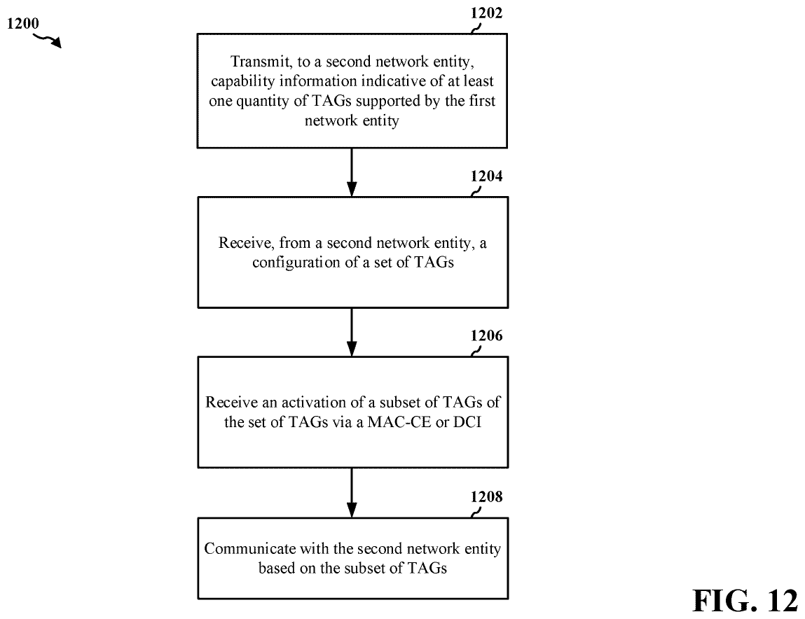

FIG. 12 is a flowchart of a method of wireless communication.

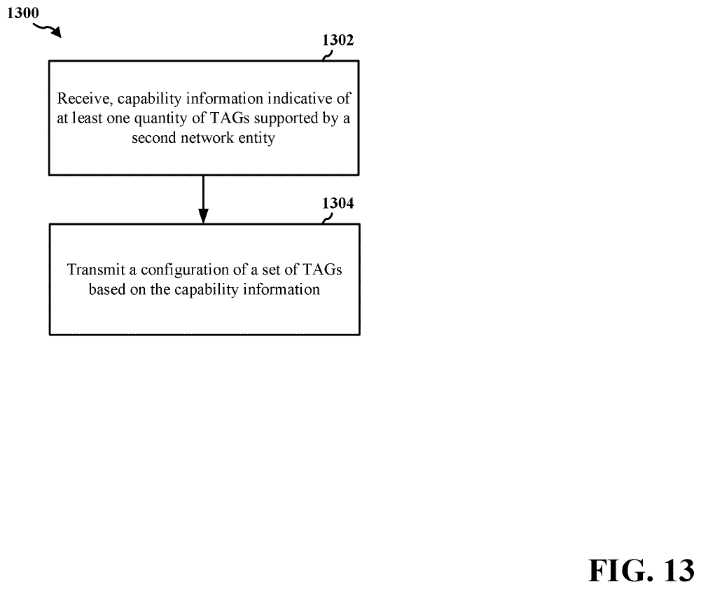

FIG. 13 is a flowchart of a method of wireless communication.

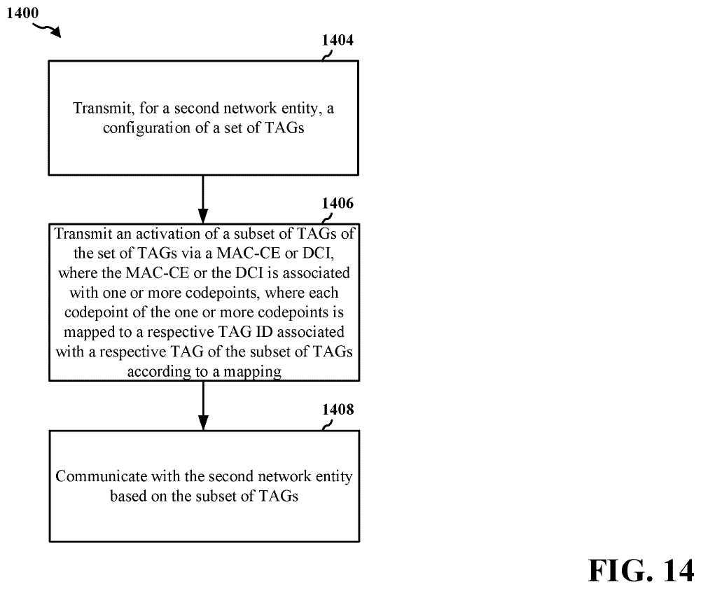

FIG. 14 is a flowchart of a method of wireless communication.

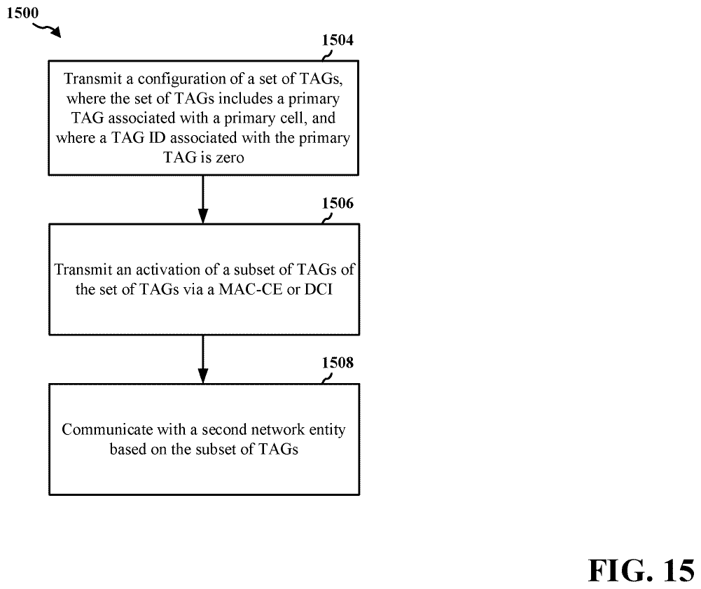

FIG. 15 is a flowchart of a method of wireless communication.

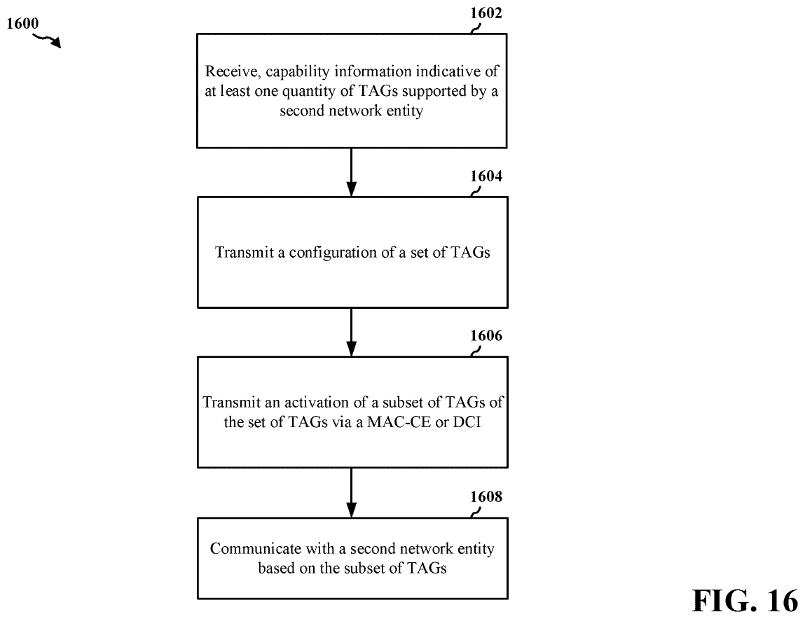

FIG. 16 is a flowchart of a method of wireless communication.

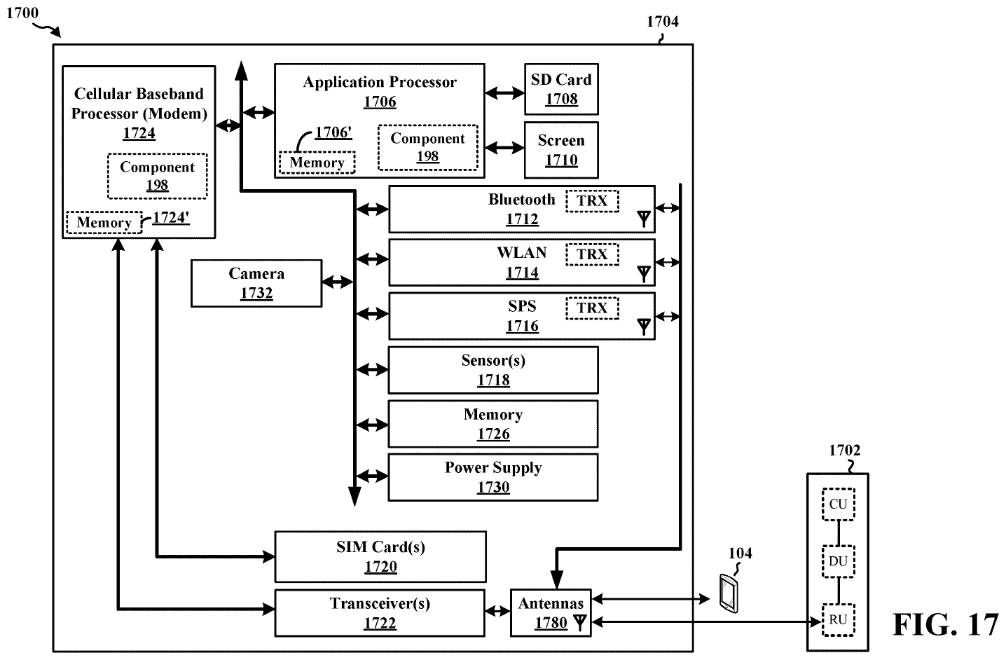

FIG. 17 is a diagram illustrating an example of a hardware implementation for an example apparatus and/or network entity.

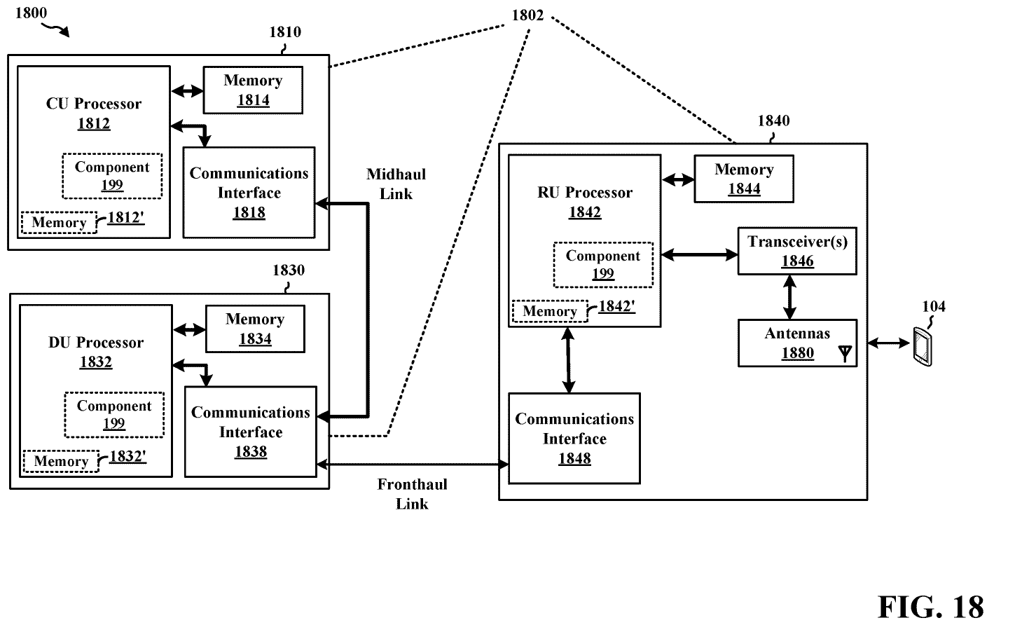

FIG. 18 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RTRIC 125. The Near-RTRIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RTRIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHZ-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a TAG component 198. The TAG component 198 may be configured to transmit, to a second network entity, capability information indicative of at least one quantity of timing advance groups (TAGs) supported by the first network entity. The TAG component 198 may be configured to receive, from the second network entity, a configuration of a set of TAGs based on the capability information. The TAG component 198 may be configured to receive, from a second network entity, a configuration of a set of TAGs. The TAG component 198 may be configured to receive an activation of a subset of TAGs of the set of TAGs via a medium access control (MAC) control element (MAC-CE) or downlink control information (DCI), where the MAC-CE or the DCI is associated with one or more codepoints, where each codepoint of the one or more codepoints is mapped to a respective TAG identifier (ID) associated with a respective TAG of the subset of TAGs according to a mapping. The TAG component 198 may be configured to communicate with the second network entity based on the subset of TAGs. The TAG component 198 may be configured to receive, from a second network entity, a configuration of a set of TAGs, where the set of TAGs includes a primary TAG associated with a primary cell, and where a TAG ID associated with the primary TAG is zero. The TAG component 198 may be configured to receive an activation of a subset of TAGs of the set of TAGs via a MAC-CE or DCI. The TAG component 198 may be configured to communicate with the second network entity based on the subset of TAGs.

In certain aspects, the base station 102 may include a TAG component 199. The TAG component 199 may be configured to receive, capability information indicative of at least one quantity of TAGs supported by a second network entity. The TAG component 199 may be configured to transmit a configuration of a set of TAGs based on the capability information. The TAG component 199 may be configured to transmit, for a second network entity, a configuration of a set of TAGs. The TAG component 199 may be configured to transmit an activation of a subset of TAGs of the set of TAGs via a MAC-CE or DCI, where the MAC-CE or the DCI is associated with one or more codepoints, where each codepoint of the one or more codepoints is mapped to a respective TAG ID associated with a respective TAG of the subset of TAGs according to a mapping. The TAG component 199 may be configured to communicate with the second network entity based on the subset of TAGs. The TAG component 199 may be configured to transmit a configuration of a set of TAGs, where the set of TAGs includes a primary TAG associated with a primary cell, and where a TAG ID associated with the primary TAG is zero. The TAG component 199 may be configured to transmit an activation of a subset of TAGs of the set of TAGs via a MAC-CE or DCI. The TAG component 199 may be configured to communicate with a second network entity based on the subset of TAGs.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI).

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

TABLE 1
Numerology, SCS, and CP

| | SCS | |
|---|---|---|
| μ | Δf = 2^{μ} · 15 [kHz] | Cyclic pre fix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with TAG component 198 of FIG. 1.

At least one of the TX processor 316, the RX processor 370, and the controller/processor 375 may be configured to perform aspects in connection with TAG component 199 of FIG. 1.

A UE may transmit a UL signal to a base station or a TRP. The UL signal may take a length of time to reach the destination base station or the TRP because the signal may travel from the UE to the destination base station or TRP for a length of time. Therefore, to meet a defined arrival time (e.g., defined based on slots or other units) in a wireless communication system, a UE in the wireless communication system may transmit UL signals based on a TA. As one example, the UE may transmit a UL signal a length of time before the defined arrival time based on a TA (e.g., to compensate the delay due to a distance between the UE and the TRP). FIG. 4 is a diagram 400 illustrating an example timing advance (TA). As illustrated in FIG. 4, a DL frame of frame number i 452 and an associated UL frame of frame number i 454 may be transmitted on a RF carrier. The UL frame of frame number i 454 may start in advance of the DL frame of frame number i 452 by a TA 456 that may be equal to (N_{TA}+N_{TA,offset}) T_{c}. The parameter T_{c} may represent a basic time unit, such as a one-bit period (e.g., approximately 3.69 microseconds). The parameter N_{TA,offset} may represent a TA defined based on a frequency band. The parameter N_{TA} may represent a TA that may be defined or signaled based on a location of the UE and the TRP or base station.

By way of example, in some wireless communication systems, the TA may be a value between 0 and 63, with each step between 0 and 63 representing an advance of one-bit period (e.g., approximately 3.69 microseconds). With signals (radio waves) travelling at about 300,000,000 meters per second (i.e., 300 meters per microsecond), one TA step then represents a change in round-trip distance (twice the propagation range) of approximately 1,100 meters. Therefore, in such an example, the TA may change for each 550-meter change in the distance between the UE and the TRP/base station.

A TAG may include one or more serving cells with a same uplink TA and a same downlink timing reference cell. Each TAG may be associated with at least one serving cell with configured uplink, and the mapping of each serving cell to a TAG may configured by radio resource control (RRC). As one example, a TAG may be associated with a PCell and one or more secondary cells. In such an example, the UE may use PCell as a timing reference. As another example, a TAG may be associated with one or more secondary cells and does not include a PCell. In such an example, the UE may use one of the activated SCells associated with the TAG as a timing reference.

As a UE moves, the PCell may be reselected or updated among a set of configured candidate PCells based on the UE's measurements (e.g., L1 measurements such as reference signal received power (RSRP), reference signal received quality (RSRQ), received signal strength indicator (RSSI), or the like) for the candidate cells. FIG. 5 is a diagram 500 illustrating an example of movement of UE and associated switching of primary cell (PCell). As illustrated in FIG. 5, as a UE 502 moves, the UE 502 may update the PCell from old PCell 504A to one of the candidate PCells including candidate PCell 504B, candidate PCell 504C, and candidate PCell 504D. The candidate PCells may be activated (e.g., the UE may receive a TAG activation from the network) before being selected as a new PCell or may be deactivated before being selected as a new PCell. In some aspects, each of the candidate PCell 504B, the candidate PCell 504C, and the candidate PCell 504D may be associated with a different TAG. For example, the candidate PCell 504B may be associated with TAG 1, the candidate PCell 504C may be associated with TAG 2, and the candidate PCell 504C may be associated with TAG 3. In some aspects, the old PCell 504A may be configured with TAG 0. In some aspects, each of TAG 0, TAG 1, TAG 2, and TAG 3 may be previously configured for the UE 502 (e.g., before the UE moves). In some aspects, in case that a TAG is assigned to each deactivated candidate PCell, there may be other cells sharing the same TAG. For example, if the candidate PCell 504B is deactivated before being selected as a new PCell, there may be other cells sharing the TAG 1 with the candidate PCell 504B. For example, the other cells sharing the TAG 1 with the candidate PCell 504B may include candidate PCell and SCells in a candidate cell group associated with a physical cell site associated with the candidate PCell 504B. In some aspects, the candidate PCell and SCells in the candidate cell group associated with a physical cell site associated with the candidate PCell 504B may not be activated until the candidate PCell 504B is activated and selected as a new PCell. In some wireless communication systems, a UE may support up to four TAGs. In some aspects, a UE may support more than four TAGs.

Aspects provided herein provide TAG mapping to facilitate more efficient signaling of TAGs. FIG. 6 is a diagram 600 illustrating example communications between a network entity 640 and a UE 620. The network entity 640 may be a network node. A network node may be implemented as an aggregated base station, a disaggregated base station, an integrated access and backhaul (IAB) node, a relay node, a sidelink node, or the like. A network entity can be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC.

In some aspects, as illustrated in FIG. 6, the UE 620 may transmit capability information 602 indicative of at least one maximum quantity (which may also be referred to as “number”) of TAGs supported by the UE 620 to the network entity 640. As used herein, the term “capability information” may be information indicative of UE capability that may be carried in a signaling. In some aspects, the capability information 602 may be indicative of maximum quantity of configured TAGs supported by the UE 620. In some aspects, the capability information 602 may be indicative of maximum quantity of configured TAGs supported by the UE 620 per band, per band combination, per feature set, or per component carrier. For example, the capability information 602 may be indicative of a maximum quantity of A configured TAGs per band, a maximum quantity of B configured TAGs per band combination, a maximum quantity of C TAGs per feature set, or a maximum quantity of D TAGs per component carrier, where each of A, B, C, and D is a positive integer. As used herein, the term “band” may refer to one frequency band out of a set of frequency bands in which a UE supports.

In some aspects, the capability information 602 may be indicative of maximum quantity of active TAGs supported by the UE 620. In some aspects, the capability information 602 may be indicative of maximum quantity of active TAGs supported by the UE 620 per band, per band combination, per feature set, or per component carrier. As used herein, the term “active TAG” may be used to refer to a TAG configured at a UE associated with an active serving cell or a TAG configured at a UE that is being actively maintained based on a request. For example, the UE may be requested to actively maintain uplink timing in a TAG for a non-active cell. As used herein, the term “configured TAG” may be used to refer to a TAG configured at a UE associated with an active serving cell or a non-active (e.g., deactivated) serving cell. For example, the capability information 602 may be indicative of a maximum quantity of E active TAGs per band, a maximum quantity of F configured TAGs per band combination, a maximum quantity of G TAGs per feature set, or a maximum quantity of H TAGs per component carrier, where each of E, F, G, and H is a positive integer. In some aspects, one or more values of A, B, C, D, E, F, G, or H may be different or same. A feature set may store a set of UE capabilities and features and an ID may be associated with each feature set. Based on the feature set ID, a feature set may be linked with more than one subset of bands (which may also be referred to as “band combination”) of multiple bands. A feature set may include a component for uplink and a separate component for downlink and may be represented by a “FeatureSet” information element. For each block of contiguous serving cells in a band or a component carrier, the set of features supported may be indicated in a feature set. A UE may indicate several feature sets for a band or a component carrier to inform different alternative features for the associated block of contiguous serving cells in that band or component carrier. As used herein, the term “component carrier” may refer to a carrier used in carrier aggregation.

In some aspects, the network entity 640 may transmit a TAG configuration 604 configuring one or more TAGS for the UE 620. In some aspects, the TAG configuration 604 may be transmitted via RRC signaling. In some aspects, the TAG configuration 604 may be based on the capability information 602. For example, in some aspects, the TAG configuration 604 may configure up to N TAGs for the UE 620, where N may be a positive integer and may be based on the capability information 602 (such as one or more of A, B, C, D, E, F, G, or H). As used herein, the term “TAG configuration” may be used interchangeably with “a configuration of a set of TAGs” and may refer to information indicative of configured TAGs for a UE.

In some aspects, the UE 620 may receive a TAG activation 606 (indicative of one or more TAGS to be activated) transmitted from the network entity 640. For example, as illustrated in FIG. 5, a UE may move and may receive a TAG activation based on the movement. In some aspects, the TAG activation 606 may be transmitted via DCI or a MAC-CE. In some aspects, the TAG activation 606 may activate M TAGs, where M may be a positive integer and may be less than or equal to M. In some aspects, the M TAGs may be a subset of the N TAGs configured for the UE 620. In some aspects, after receiving the TAG activation 606, the network entity 640 may transmit a TA signaling 607 to the UE 620 to indicate an active TAG to be used for a communication 608. In some aspects, the UE 620 and the network entity 640 may communicate based on TA signaling 607. Aspects provided herein may reduce signaling overhead associated with a TA signaling, such as the TA signaling 607. Referring now to FIG. 7A, FIG. 7A is a diagram 700 illustrating an example mapping of TAG ID and TAG codepoints. In some aspects, each TAG ID may be associated with a serving cell ID. As illustrated in FIG. 7A, to reduce the number of bits for TAG ID in TA signaling (such as TA signaling 607 via MAC-CE or DCI), the TA signaling 607 may be based on a code point of a set of TAG codepoints. Each codepoint value of the set of TAG codepoints may be indicative of one of the active TAG IDs (e.g., configured by the TAG activation 606). In some aspects, the multiple active TAG IDs (configured by the TAG activation 606) may be one-to-one mapped to the multiple codepoints that may be used in TA signaling (such as the TA signaling 607). For example, a UE may be configured with eight TAGs with TAG ID 0 to 7. The activated TAGs may be TAG ID 0, TAG ID 2, TAG ID 3, and TAG ID 6, which may be one-to-one mapped to four TAG codepoints including TAG codepoint 0, TAG codepoint 1, TAG codepoint 2, and TAG codepoint 3 based on an ascending order. As one example, if TA signaling (such as the TA signaling 607) includes TAG codepoint 1, the UE may communicate with the network entity based on TAG ID 2. FIG. 7B is a diagram 750 illustrating an example mapping of TAG ID and TAG codepoints. The activated TAGs may be TAG ID 6, TAGID 3, TAGID 2, and TAG ID 0, which may be one-to-one mapped to four TAG codepoints including TAG codepoint 0, TAG codepoint 1, TAG codepoint 2, and TAG codepoint 3 based on a descending order. As one example, if TA signaling (such as the TA signaling 607) includes TAG codepoint 2, the UE may communicate with the network entity based on TAG ID 2.

In some aspects, a primary TAG that may be applied to at least the primary cell (e.g., and one or more secondary cells) may have TAG ID 0. FIG. 8 is a diagram 800 illustrating an example mapping of TAG ID, TAG codepoints, and serving cell ID. As illustrated in FIG. 8, a UE may be configured with eight TAGs with TAG ID 0 to 7. The activated TAGs may be TAG ID 0, TAG ID 2, TAG ID 3, and TAG ID 6, which may be one-to-one mapped to four TAG codepoints including TAG codepoint 0, TAG codepoint 1, TAG codepoint 2, and TAG codepoint 3 based on an ascending order. TAG ID 0 may be applied to a primary cell with serving cell ID 0. TAG ID 0 may also be applied to another serving cell with serving cell ID 1. TAG ID 2 may be applied to a serving cell with serving cell ID 2. TAG ID 3 may be applied to a serving cell with serving cell ID 3. TAG ID 6 may be applied to a serving cell with serving cell ID 6.

FIG. 9 is a flowchart 900 of a method of wireless communication. The method may be performed by a first network entity (e.g., the UE 104, the UE 620; the apparatus 1704).

At 902, the first network entity may transmit, to a second network entity, capability information indicative of at least one quantity of TAGs supported by the first network entity. For example, the UE 620 may transmit, to a network entity 640, capability information 602 indicative of at least one quantity of TAGs supported by the first network entity. In some aspects, 902 may be performed by TAG component 198.

At 904, the first network entity may receive, from the second network entity, a configuration of a set of TAGs based on the capability information. For example, the UE 620 may receive, from the second network entity, a configuration (e.g., TAG configuration 604) of a set of TAGs based on the capability information. In some aspects, 904 may be performed by TAG component 198.

FIG. 10 is a flowchart 1000 of a method of wireless communication. The method may be performed by a first network entity (e.g., the UE 104, the UE 620; the apparatus 1704).

At 1004, the first network entity may receive, from the second network entity, a configuration of a set of TAGs. For example, the UE 620 may receive, from the second network entity, a configuration (e.g., TAG configuration 604) of a set of TAGs (e.g., based on capability information 602). In some aspects, 904 may be performed by TAG component 198.

At 1006, the first network entity may receive an activation of a subset of TAGs of the set of TAGs via a MAC-CE or DCI. In some aspects, the MAC-CE or the DCI is associated with one or more codepoints, where each codepoint of the one or more codepoints is mapped to a respective TAG ID associated with a respective TAG of the subset of TAGs according to a mapping. For example, the UE 620 may receive an activation (e.g., 606) of a subset of TAGs of the set of TAGs via a MAC-CE or DCI, where the MAC-CE or the DCI is associated with one or more codepoints, where each codepoint of the one or more codepoints is mapped to a respective TAG ID associated with a respective TAG of the subset of TAGs according to a mapping. In some aspects, 1006 may be performed by TAG component 198.

At 1008, the first network entity may communicate with the second network entity based on the subset of TAGs. For example, the UE 620 may communicate with the network entity 640 (e.g., 608) based on the subset of TAGs (e.g., and a TA signaling 607). In some aspects, 1008 may be performed by TAG component 198.

FIG. 11 is a flowchart 1100 of a method of wireless communication. The method may be performed by a first network entity (e.g., the UE 104, the UE 620; the apparatus 1704).

At 1104, the first network entity may receive, from the second network entity, a configuration of a set of TAGs. In some aspects, the set of TAGs includes a primary TAG associated with a primary cell, and where a TAG ID associated with the primary TAG is zero. For example, the UE 620 may receive, from the second network entity, a configuration (e.g., TAG configuration 604) of a set of TAGs (e.g., based on capability information 602). In some aspects, 904 may be performed by TAG component 198.

At 1106, the first network entity may receive an activation of a subset of TAGs of the set of TAGs via a MAC-CE or DCI. In some aspects, the MAC-CE or the DCI is associated with one or more codepoints, where each codepoint of the one or more codepoints is mapped to a respective TAG ID associated with a respective TAG of the subset of TAGs according to a mapping. For example, the UE 620 may receive an activation (e.g., 606) of a subset of TAGs of the set of TAGs via a MAC-CE or DCI, where the MAC-CE or the DCI is associated with one or more codepoints, where each codepoint of the one or more codepoints is mapped to a respective TAG ID associated with a respective TAG of the subset of TAGs according to a mapping. In some aspects, 1106 may be performed by TAG component 198.

At 1108, the first network entity may communicate with the second network entity based on the subset of TAGs. For example, the UE 620 may communicate with the network entity 640 (e.g., 608) based on the subset of TAGs (e.g., and a TA signaling 607). In some aspects, 1108 may be performed by TAG component 198.

FIG. 12 is a flowchart 1200 of a method of wireless communication. The method may be performed by a first network entity (e.g., the UE 104, the UE 620; the apparatus 1704).

At 1202, the first network entity may transmit, to a second network entity, capability information indicative of at least one quantity of TAGs supported by the first network entity. For example, the UE 620 may transmit, to a network entity 640, capability information 602 indicative of at least one quantity of TAGs supported by the first network entity. In some aspects, 1202 may be performed by TAG component 198. In some aspects, the at least one quantity of TAGs includes at least one maximum quantity of configured TAGs associated with one of: each band of the group of bands associated with the first network entity, each subset of bands of the one or more subsets of the group of bands, each feature set of the one or more feature sets associated with the first network entity, or each component carrier of the set of component carriers associated with the first network entity (e.g., A, B, C, or D described in connection with FIG. 6).

At 1204, the first network entity may receive, from the second network entity, a configuration of a set of TAGs (e.g., based on capability information). In some aspects, the set of TAGs includes a primary TAG associated with a primary cell, and where a TAG ID associated with the primary TAG is zero. For example, the UE 620 may receive, from the second network entity, a configuration (e.g., TAG configuration 604) of a set of TAGs (e.g., based on capability information 602). In some aspects, 1204 may be performed by TAG component 198. In some aspects, to receive the configuration of the set of TAGs, the UE may receive the configuration of the set of TAGs via RRC signaling, where a first quantity of the set of TAGs is less than or equal to N, where N is a positive integer based on the at least one maximum quantity of configured TAGs. In some aspects, the at least one quantity of TAGs includes at least one maximum quantity of active TAGs associated with one of: each band of the group of bands associated with the first network entity, each subset of bands of the one or more subsets of the group of bands, each feature set of the one or more feature sets associated with the first network entity, or each component carrier of the set of component carriers associated with the first network entity (e.g., E, F, G, or H described in connection with FIG. 6).

At 1206, the first network entity may receive an activation of a subset of TAGs of the set of TAGs via a MAC-CE or DCI. In some aspects, a second quantity of the subset of TAGs is M, where M is less than or equal to N. In some aspects, the MAC-CE or the DCI is associated with one or more codepoints, where each codepoint of the one or more codepoints is mapped to a respective TAG ID associated with a respective TAG of the subset of TAGs according to a mapping. For example, the UE 620 may receive an activation (e.g., 606) of a subset of TAGs of the set of TAGs via a MAC-CE or DCI, where the MAC-CE or the DCI includes (or may be associated with) one or more codepoints, where each codepoint of the one or more codepoints is mapped to a respective TAG ID associated with a respective TAG of the subset of TAGs according to a mapping. In some aspects, 1206 may be performed by TAG component 198. In some aspects, the MAC-CE or the DCI includes (or may be associated with) the one or more codepoints in an ascending order or a descending order of the respective TAG ID mapped to each codepoint of the one or more codepoints. In some aspects, the mapping is an ascending order or a descending order. In some aspects, in accordance with the ascending order, a first TAG of the subset of TAGs having a lowest TAG ID is mapped to a first codepoint of the one or more codepoints and a second TAG of the subset of TAGs having a second lowest TAG ID is mapped to a second codepoint of the one or more codepoints. For example, as illustrated in FIG. 7A, TAG ID 0 may be mapped to a first codepoint 0, TAG ID 2 may be mapped to a second codepoint 1, TAG ID 3 may be mapped to a third codepoint 2, and TAG ID 6 may be mapped to a fourth codepoint 3. In some aspects, in accordance with the descending order, a first TAG of the subset of TAGs having a highest TAG ID is mapped to a first codepoint of the one or more codepoints and a second TAG of the subset of TAGs having a second highest TAG ID is mapped to a second codepoint of the one or more codepoints. For example, as illustrated in FIG. 7A, TAG ID 6 may be mapped to a first codepoint 0, TAG ID 3 may be mapped to a second codepoint 1, TAG ID 2 may be mapped to a third codepoint 2, and TAG ID 0 may be mapped to a fourth codepoint 3.

At 1208, the first network entity may communicate with the second network entity based on the subset of TAGs. For example, the UE 620 may communicate with the network entity 640 (e.g., 608) based on the subset of TAGs (e.g., and a TA signaling 607). In some aspects, 1208 may be performed by TAG component 198.

FIG. 13 is a flowchart 1300 of a method of wireless communication. The method may be performed by a network entity (e.g., the base station 102, the network entity 640, the network entity 1702, the network entity 1802).

At 1302, the network entity may receive, capability information indicative of at least one quantity of TAGs supported by a second network entity. For example, the network entity 640 may receive, capability information (e.g., 602) indicative of at least one quantity of TAGs supported by a second network entity (e.g., UE 620). In some aspects, 1302 may be performed by TAG component 199.

At 1304, the network entity may transmit a configuration of a set of TAGs (e.g., based on the capability information). In some aspects, the set of TAGs includes a primary TAG associated with a primary cell, and where a TAG ID associated with the primary TAG is zero. For example, the network entity 640 may transmit a configuration (e.g., 604) of a set of TAGs (e.g., based on the capability information 602). In some aspects, 1304 may be performed by TAG component 199.

FIG. 14 is a flowchart 1400 of a method of wireless communication. The method may be performed by a network entity (e.g., the base station 102, the network entity 640, the network entity 1702, the network entity 1802).

At 1404, the network entity may transmit a configuration of a set of TAGs (e.g., based on the capability information). In some aspects, the set of TAGs includes a primary TAG associated with a primary cell, and where a TAG ID associated with the primary TAG is zero. For example, the network entity 640 may transmit a configuration (e.g., 604) of a set of TAGs (e.g., based on the capability information 602). In some aspects, 1404 may be performed by TAG component 199.

At 1406, the network entity may transmit an activation of a subset of TAGs of the set of TAGs via a MAC-CE or DCI. In some aspects, the MAC-CE or the DCI is associated with one or more codepoints, where each codepoint of the one or more codepoints is mapped to a respective TAG ID associated with a respective TAG of the subset of TAGs according to a mapping. For example, the network entity 640 may transmit an activation (e.g., 606) of a subset of TAGs of the set of TAGs via a MAC-CE or DCI. In some aspects, 1406 may be performed by TAG component 199.

At 1408, the network entity may communicate with the second network entity based on the subset of TAGs. For example, the network entity 640 may communicate (e.g., 608) with the second network entity based on the subset of TAGs (e.g., and a TA signaling 607). In some aspects, 1408 may be performed by TAG component 199.

FIG. 15 is a flowchart 1500 of a method of wireless communication. The method may be performed by a network entity (e.g., the base station 102, the network entity 640, the network entity 1702, the network entity 1802).

At 1504, the network entity may transmit a configuration of a set of TAGs (e.g., based on the capability information). In some aspects, the set of TAGs includes a primary TAG associated with a primary cell, and where a TAG ID associated with the primary TAG is zero. For example, the network entity 640 may transmit a configuration (e.g., 604) of a set of TAGs (e.g., based on the capability information 602). In some aspects, 1504 may be performed by TAG component 199.

At 1506, the network entity may transmit an activation of a subset of TAGs of the set of TAGs via a MAC-CE or DCI. In some aspects, the MAC-CE or the DCI is associated with one or more codepoints, where each codepoint of the one or more codepoints is mapped to a respective TAG ID associated with a respective TAG of the subset of TAGs according to a mapping. For example, the network entity 640 may transmit an activation (e.g., 606) of a subset of TAGs of the set of TAGs via a MAC-CE or DCI. In some aspects, 1506 may be performed by TAG component 199.

At 1508, the network entity may communicate with the second network entity based on the subset of TAGs. For example, the network entity 640 may communicate (e.g., 608) with the second network entity based on the subset of TAGs (e.g., and a TA signaling 607). In some aspects, 1508 may be performed by TAG component 199.

FIG. 16 is a flowchart 1600 of a method of wireless communication. The method may be performed by a network entity (e.g., the base station 102, the network entity 640, the network entity 1702, the network entity 1802).

At 1602, the network entity may receive, capability information indicative of at least one quantity of TAGs supported by a second network entity. For example, the network entity 640 may receive, capability information (e.g., 602) indicative of at least one quantity of TAGs supported by a second network entity (e.g., UE 620). In some aspects, 1602 may be performed by TAG component 199. In some aspects, the at least one quantity of TAGs includes at least one maximum quantity of configured TAGs associated with one of: each band of the group of bands associated with the first network entity, each subset of bands of the one or more subsets of the group of bands, each feature set of the one or more feature sets associated with the first network entity, or each component carrier of the set of component carriers associated with the first network entity (e.g., A, B, C, or D described in connection with FIG. 6). In some aspects, the at least one quantity of TAGs includes at least one maximum quantity of active TAGs associated with one of: each band of the group of bands associated with the first network entity, each subset of bands of the one or more subsets of the group of bands, each feature set of the one or more feature sets associated with the first network entity, or each component carrier of the set of component carriers associated with the first network entity (e.g., E, F, G, or H described in connection with FIG. 6). At 1604, the network entity may transmit a configuration of a set of TAGs (e.g., based on the capability information). In some aspects, the set of TAGs includes a primary TAG associated with a primary cell, and where a TAG ID associated with the primary TAG is zero. For example, the network entity 640 may transmit a configuration (e.g., 604) of a set of TAGs (e.g., based on the capability information 602). In some aspects, 1604 may be performed by TAG component 199. In some aspects, to transmit the configuration of the set of TAGs, the network entity may transmit the configuration of the set of TAGs via RRC signaling, where a first quantity of the set of TAGs is less than or equal to N, where N is a positive integer based on the at least one maximum quantity of configured TAGs.

At 1606, the network entity may transmit an activation of a subset of TAGs of the set of TAGs via a MAC-CE or DCI. In some aspects, the MAC-CE or the DCI includes (or may be associated with) one or more codepoints, where each codepoint of the one or more codepoints is mapped to a respective TAG ID associated with a respective TAG of the subset of TAGs according to a mapping. For example, the network entity 640 may transmit an activation (e.g., 606) of a subset of TAGs of the set of TAGs via a MAC-CE or DCI. In some aspects, 1606 may be performed by TAG component 199. In some aspects, a second quantity of the subset of TAGs is M, where M is less than or equal to N. In some aspects, the MAC-CE or the DCI includes (or may be associated with) the one or more codepoints in an ascending order or a descending order of the respective TAG ID mapped to each codepoint of the one or more codepoints. In some aspects, the mapping is an ascending order or a descending order. In some aspects, in accordance with the ascending order, a first TAG of the subset of TAGs having a lowest TAG ID is mapped to a first codepoint of the one or more codepoints and a second TAG of the subset of TAGs having a second lowest TAG ID is mapped to a second codepoint of the one or more codepoints. For example, as illustrated in FIG. 7A, TAG ID 0 may be mapped to a first codepoint 0, TAG ID 2 may be mapped to a second codepoint 1, TAG ID 3 may be mapped to a third codepoint 2, and TAG ID 6 may be mapped to a fourth codepoint 3. In some aspects, in accordance with the descending order, a first TAG of the subset of TAGs having a highest TAG ID is mapped to a first codepoint of the one or more codepoints and a second TAG of the subset of TAGs having a second highest TAG ID is mapped to a second codepoint of the one or more codepoints. For example, as illustrated in FIG. 7A, TAG ID 6 may be mapped to a first codepoint 0, TAG ID 3 may be mapped to a second codepoint 1, TAG ID 2 may be mapped to a third codepoint 2, and TAG ID 0 may be mapped to a fourth codepoint 3.

At 1608, the network entity may communicate with the second network entity based on the subset of TAGs. For example, the network entity 640 may communicate (e.g., 608) with the second network entity based on the subset of TAGs (e.g., and a TA signaling 607). In some aspects, 1608 may be performed by TAG component 199.

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include a cellular baseband processor 1724 (also referred to as a modem) coupled to one or more transceivers 1722 (e.g., cellular RF transceiver). The cellular baseband processor 1724 may include on-chip memory 1724′. In some aspects, the apparatus 1704 may further include one or more subscriber identity modules (SIM) cards 1720 and an application processor 1706 coupled to a secure digital (SD) card 1708 and a screen 1710. The application processor 1706 may include on-chip memory 1706′. In some aspects, the apparatus 1704 may further include a Bluetooth module 1712, a WLAN module 1714, a satellite system module 1716 (e.g., GNSS module), one or more sensor modules 1718 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the satellite system module 1716 may include an on-chip transceiver (TRX)/receiver (RX). The cellular baseband processor 1724 communicates through the transceiver(s) 1722 via one or more antennas 1780 with the UE 104 and/or with an RU associated with a network entity 1702. The cellular baseband processor 1724 and the application processor 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described herein. The computer-readable medium/memory may also be used for storing data that is manipulated by the cellular baseband processor 1724/application processor 1706 when executing software. The cellular baseband processor 1724/application processor 1706 may be a component of the UE 350 and may include the memory 360 and/or at least one of the TX processor 368, the RX processor 356, and the controller/processor 359. In one configuration, the apparatus 1704 may be a processor chip (modem and/or application) and include just the cellular baseband processor 1724 and/or the application processor 1706, and in another configuration, the apparatus 1704 may be the entire UE (e.g., see 350 of FIG. 3) and include the additional modules of the apparatus 1704.

As discussed herein, the TAG component 198 may be configured to transmit, to a second network entity, capability information indicative of at least one quantity of timing advance groups (TAGs) supported by the first network entity. The TAG component 198 may be configured to receive, from the second network entity, a configuration of a set of TAGs based on the capability information. The TAG component 198 may be configured to receive, from a second network entity, a configuration of a set of TAGs. The TAG component 198 may be configured to receive an activation of a subset of TAGs of the set of TAGs via a medium access control (MAC) control element (MAC-CE) or downlink control information (DCI), where the MAC-CE or the DCI is associated with one or more codepoints, where each codepoint of the one or more codepoints is mapped to a respective TAG identifier (ID) associated with a respective TAG of the subset of TAGs according to a mapping. The TAG component 198 may be configured to communicate with the second network entity based on the subset of TAGs. The TAG component 198 may be configured to receive, from a second network entity, a configuration of a set of TAGS, where the set of TAGs includes a primary TAG associated with a primary cell, and where a TAG ID associated with the primary TAG is zero. The TAG component 198 may be configured to receive an activation of a subset of TAGs of the set of TAGs via a MAC-CE or DCI. The TAG component 198 may be configured to communicate with the second network entity based on the subset of TAGs. The TAG component 198 may be within the cellular baseband processor 1724, the application processor 1706, or both the cellular baseband processor 1724 and the application processor 1706. The TAG component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1704 may include a variety of components configured for various functions. In one configuration, the apparatus 1704, and in particular the cellular baseband processor 1724 and/or the application processor 1706, includes means for transmitting, to a second network entity, capability information indicative of at least one quantity of TAGs supported by the first network entity. In some aspects, the apparatus 1704 may further include means for receiving, from a second network entity, a configuration of a set of TAGs (which may include means for receiving the configuration of the set of TAGs via RRC signaling). In some aspects, the apparatus 1704 may further include means for receiving an activation of a subset of TAGs of the set of TAGs via a MAC-CE or DCI. In some aspects, the apparatus 1704 may further include means for communicating with the second network entity based on the subset of TAGs. The means may be the TAG component 198 of the apparatus 1704 configured to perform the functions recited by the means. As described herein, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include a CU processor 1812. The CU processor 1812 may include on-chip memory 1812′. In some aspects, the CU 1810 may further include additional memory modules 1814 and a communications interface 1818. The CU 1810 communicates with the DU 1830 through a midhaul link, such as an F1 interface. The DU 1830 may include a DU processor 1832. The DU processor 1832 may include on-chip memory 1832′. In some aspects, the DU 1830 may further include additional memory modules 1834 and a communications interface 1838. The DU 1830 communicates with the RU 1840 through a fronthaul link. The RU 1840 may include an RU processor 1842. The RU processor 1842 may include on-chip memory 1842′. In some aspects, the RU 1840 may further include additional memory modules 1844, one or more transceivers 1846, antennas 1880, and a communications interface 1848. The RU 1840 communicates with the UE 104. The on-chip memory 1812′, 1832′, 1842′ and the additional memory modules 1814, 1834, 1844 may each be considered a computer-readable medium/memory. Each computer-readable medium/memory may be non-transitory. Each of the processors 1812, 1832, 1842 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

As discussed herein, the TAG component 199 may be configured to receive, capability information indicative of at least one quantity of TAGs supported by a second network entity. The TAG component 199 may be configured to transmit a configuration of a set of TAGs based on the capability information. The TAG component 199 may be configured to transmit, for a second network entity, a configuration of a set of TAGs. The TAG component 199 may be configured to transmit an activation of a subset of TAGs of the set of TAGs via a MAC-CE or DCI, where the MAC-CE or the DCI is associated with one or more codepoints, where each codepoint of the one or more codepoints is mapped to a respective TAG ID associated with a respective TAG of the subset of TAGs according to a mapping. The TAG component 199 may be configured to communicate with the second network entity based on the subset of TAGs. The TAG component 199 may be configured to transmit a configuration of a set of TAGs, where the set of TAGs includes a primary TAG associated with a primary cell, and where a TAG ID associated with the primary TAG is zero. The TAG component 199 may be configured to transmit an activation of a subset of TAGs of the set of TAGs via a MAC-CE or DCI. The TAG component 199 may be configured to communicate with a second network entity based on the subset of TAGs. The TAG component 199 may be within one or more processors of one or more of the CU 1810, DU 1830, and the RU 1840. The TAG component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1802 may include a variety of components configured for various functions. In one configuration, the network entity 1802 includes means for receiving, capability information indicative of at least one quantity of TAGs supported by a second network entity. In some aspects, the network entity 1802 may further include means for transmitting a configuration of a set of TAGs (which may include means for transmitting the configuration of the set of TAGs via RRC signaling). In some aspects, the network entity 1802 may further include means for transmitting an activation of a subset of TAGs of the set of TAGs via a MAC-CE or DCI. In some aspects, the network entity 1802 may further include means for communicating with a second network entity based on the subset of TAGs. The means may be the TAG component 199 of the network entity 1802 configured to perform the functions recited by the means. As described herein, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented. The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a first network entity for wireless communication, including: a memory; and at least one processor coupled to the memory, where the at least one processor is configured to: transmit, to a second network entity, capability information indicative of at least one quantity of timing advance groups (TAGs) supported by the first network entity; and receive, from the second network entity, a configuration of a set of TAGs based on the capability information.

Aspect 2 is the first network entity of aspect 1, where the at least one quantity of TAGs includes at least one maximum quantity of configured TAGs, and where each respective maximum quantity of the at least one maximum quantity of configured TAGs is associated with one of: each band of a group of bands associated with the first network entity, each subset of bands of one or more subsets of the group of bands, each feature set of one or more feature sets associated with the first network entity, or each component carrier of a set of component carriers associated with the first network entity.

Aspect 3 is the first network entity of any of aspects 1-2, where to receive the configuration of the set of TAGs, the at least one processor is configured to receive the configuration of the set of TAGs via radio resource control (RRC) signaling, where a first quantity of the set of TAGs is less than or equal to N, where N is a positive integer based on the at least one maximum quantity of configured TAGs.

Aspect 4 is the first network entity of any of aspects 1-3, where the at least one quantity of TAGs includes at least one maximum quantity of active TAGs, and where each respective maximum quantity of the at least one maximum quantity of configured TAGs is associated with one of: each band of the group of bands associated with the first network entity, each subset of bands of the one or more subsets of the group of bands, each feature set of the one or more feature sets associated with the first network entity, or each component carrier of the set of component carriers associated with the first network entity.

Aspect 5 is the first network entity of any of aspects 1-4, where the at least one processor is configured to receive an activation of a subset of TAGs of the set of TAGs via a medium access control (MAC) control element (MAC-CE) or downlink control information (DCI), and where a second quantity of the subset of TAGs is M, where M is less than or equal to N.

Aspect 6 is the first network entity of any of aspects 1-5, where the MAC-CE or the DCI is associated with one or more codepoints, and where each codepoint of the one or more codepoints is mapped to a respective TAG identifier (ID) associated with a respective TAG of the subset of TAGs according to a mapping.

Aspect 7 is the first network entity of any of aspects 1-6, where the mapping is an ascending order or a descending order.

Aspect 8 is the first network entity of any of aspects 1-7, where, in accordance with the ascending order, a first TAG of the subset of TAGs having a lowest TAG ID is mapped to a first codepoint of the one or more codepoints and a second TAG of the subset of TAGs having a second lowest TAG ID is mapped to a second codepoint of the one or more codepoints.

Aspect 9 is the first network entity of any of aspects 1-7, where, in accordance with the descending order, a first TAG of the subset of TAGs having a highest TAG ID is mapped to a first codepoint of the one or more codepoints and a second TAG of the subset of TAGs having a second highest TAG ID is mapped to a second codepoint of the one or more codepoints.

Aspect 10 is the first network entity of any of aspects 1-9, where the set of TAGs includes a primary TAG associated with a primary cell, and where a TAG identifier (ID) associated with the primary TAG is zero.

Aspect 11 is a first network entity for wireless communication, including: a memory; and at least one processor coupled to the memory, where the at least one processor is configured to: receive, from a second network entity, a configuration of a set of timing advance groups (TAGs); receive an activation of a subset of TAGs of the set of TAGs via a medium access control (MAC) control element (MAC-CE) or downlink control information (DCI), where the MAC-CE or the DCI is associated with one or more codepoints, and where each codepoint of the one or more codepoints is mapped to a respective TAG identifier (ID) associated with a respective TAG of the subset of TAGs according to a mapping; and communicate with the second network entity based on the subset of TAGs.

Aspect 12 is the first network entity of aspect 11, where the mapping is an ascending order or a descending order.

Aspect 13 is the first network entity of any of aspects 11-12, where, in accordance with the ascending order, a first TAG of the subset of TAGs having a lowest TAG ID is mapped to a first codepoint of the one or more codepoints and a second TAG of the subset of TAGs having a second lowest TAG ID is mapped to a second codepoint of the one or more codepoints.

Aspect 14 is the first network entity of any of aspects 11-12, where, in accordance with the descending order, a first TAG of the subset of TAGs having a highest TAG ID is mapped to a first codepoint of the one or more codepoints and a second TAG of the subset of TAGs having a second highest TAG ID is mapped to a second codepoint of the one or more codepoints.

Aspect 15 is the first network entity of any of aspects 11-14, where the at least one processor is configured to: transmit, to the second network entity, capability information indicative of at least one quantity of TAGs supported by the first network entity, where the configuration of the set of TAGs is based on the capability information.

Aspect 16 is the first network entity of any of aspects 11-15, where the at least one quantity of TAGs includes at least one maximum quantity of configured TAGs, and where each respective maximum quantity of the at least one maximum quantity of configured TAGs is associated with one of: each band of a group of bands associated with the first network entity, each subset of bands of one or more subsets of the group of bands, each feature set of one or more feature sets associated with the first network entity, or each component carrier of a set of component carriers associated with the first network entity.

Aspect 17 is the first network entity of any of aspects 11-16, where to receive the configuration of the set of TAGs, the at least one processor is configured to receive the configuration of the set of TAGs via radio resource control (RRC) signaling, where a first quantity of the set of TAGs is less than or equal to N, where N is a positive integer based on the at least one maximum quantity of configured TAGs.

Aspect 18 is the first network entity of any of aspects 11-17, where the at least one quantity of TAGs includes at least one maximum quantity of active TAGs, and where each respective maximum quantity of the at least one maximum quantity of configured TAGs is associated with one of: each band of the group of bands associated with the first network entity, each subset of bands of the one or more subsets of the group of bands, each feature set of the one or more feature sets associated with the first network entity, or each component carrier of the set of component carriers associated with the first network entity.

Aspect 19 is the first network entity of any of aspects 11-18, where a second quantity of the subset of TAGs is M, where M is less than or equal to N.

Aspect 20 is the first network entity of any of aspects 11-19, where the set of TAGs includes a primary TAG associated with a primary cell, and where a TAG ID associated with the primary TAG is zero.

Aspect 21 is a first network entity for wireless communication, including: a memory; and at least one processor coupled to the memory, where the at least one processor is configured to: receive, from a second network entity, a configuration of a set of timing advance groups (TAGs), where the set of TAGs includes a primary TAG associated with a primary cell, and where a TAG identifier (ID) associated with the primary TAG is zero; receive an activation of a subset of TAGs of the set of TAGs via a medium access control (MAC) control element (MAC-CE) or downlink control information (DCI); and communicate with the second network entity based on the subset of TAGs.

Aspect 22 is the first network entity of aspect 21, where the MAC-CE or the DCI is associated with one or more codepoints, where each codepoint of the one or more codepoints is mapped to a respective TAG ID associated with a respective TAG of the subset of TAGs according to a mapping.

Aspect 23 is the first network entity of any of aspects 21-22, where the mapping is an ascending order or a descending order.

Aspect 24 is the first network entity of any of aspects 21-23, where, in accordance with the ascending order, a first TAG of the subset of TAGs having a lowest TAG ID is mapped to a first codepoint of the one or more codepoints and a second TAG of the subset of TAGs having a second lowest TAG ID is mapped to a second codepoint of the one or more codepoints.

Aspect 25 is the first network entity of any of aspects 21-23, where, in accordance with the descending order, a first TAG of the subset of TAGs having a highest TAG

ID is mapped to a first codepoint of the one or more codepoints and a second TAG of the subset of TAGs having a second highest TAG ID is mapped to a second codepoint of the one or more codepoints.

Aspect 26 is the first network entity of any of aspects 21-25, where the at least one processor is configured to: transmit, to the second network entity, capability information indicative of at least one quantity of TAGs supported by the first network entity, where the configuration of the set of TAGs is based on the capability information.

Aspect 27 is the first network entity of any of aspects 21-26, where the at least one quantity of TAGs includes at least one maximum quantity of configured TAGs, and where each respective maximum quantity of the at least one maximum quantity of configured TAGs is associated with one of: each band of a group of bands associated with the first network entity, each subset of bands of one or more subsets of the group of bands, each feature set of one or more feature sets associated with the first network entity, or each component carrier of a set of component carriers associated with the first network entity.

Aspect 28 is the first network entity of any of aspects 21-27, where to receive the configuration of the set of TAGs, the at least one processor is configured to receive the configuration of the set of TAGs via radio resource control (RRC) signaling, where a first quantity of the set of TAGs is less than or equal to N, where N is a positive integer based on the at least one maximum quantity of configured TAGs.

Aspect 29 is the first network entity of any of aspects 21-28, where the at least one quantity of TAGs includes at least one maximum quantity of active TAGs, and where each respective maximum quantity of the at least one maximum quantity of configured TAGs is associated with one of: each band of the group of bands associated with the first network entity, each subset of bands of the one or more subsets of the group of bands, each feature set of the one or more feature sets associated with the first network entity, or each component carrier of the set of component carriers associated with the first network entity.

Aspect 30 is the first network entity of any of aspects 21-29, where a second quantity of the subset of TAGs is M, where M is less than or equal to N.

Aspect 31 is a first network entity for wireless communication, including: a memory; and at least one processor coupled to the memory, where the at least one processor is configured to: receive capability information indicative of at least one quantity of timing advance groups (TAGs) supported by a second network entity; and transmit, for the second network entity, a configuration of a set of TAGs based on the capability information.

Aspect 32 is the first network entity of aspect 1, where the at least one quantity of TAGs includes at least one maximum quantity of configured TAGs, and where each respective maximum quantity of the at least one maximum quantity of configured TAGs is associated with one of: each band of a group of bands associated with the second network entity, each subset of bands of one or more subset of the group of bands, each feature set of one or more feature sets associated with the second network entity, or each component carrier of a set of component carriers associated with the second network entity.

Aspect 33 is the first network entity of any of aspects 32, where to transmit the configuration of the set of TAGs, the at least one processor is configured to transmit the configuration of the set of TAGs via radio resource control (RRC) signaling, where a first quantity of the set of TAGs is less than or equal to N, where N is a positive integer based on the at least one maximum quantity of configured TAGs.

Aspect 34 is the first network entity of any of aspects 33, where the at least one quantity of TAGs includes at least one maximum quantity of active TAGs, and where each respective maximum quantity of the at least one maximum quantity of configured TAGs is associated with one of: each band of the group of bands associated with the second network entity, each subset of bands of the one or more subsets of the group of bands, each feature set of the one or more feature sets associated with the second network entity, or each component carrier of the set of component carriers associated with the second network entity.

Aspect 35 is the first network entity of any of aspects 31-34, where the at least one processor is configured to transmit an activation of a subset of TAGs of the set of TAGs via a medium access control (MAC) control element (MAC-CE) or downlink control information (DCI), and where a second quantity of the subset of TAGs is M, where M is less than or equal to N.

Aspect 36 is the first network entity of any of aspects 31-35, where the MAC-CE or the DCI is associated with one or more codepoints, and where each codepoint of the one or more codepoints is mapped to a respective TAG identifier (ID) associated with a respective TAG of the subset of TAGs according to a mapping.

Aspect 37 is the first network entity of any of aspects 31-36, where the mapping is an ascending order or a descending order.

Aspect 38 is the first network entity of any of aspects 31-37, where, in accordance with the ascending order, a first TAG of the subset of TAGs having a lowest TAG ID is mapped to a first codepoint of the one or more codepoints and a second TAG of the subset of TAGs having a second lowest TAG ID is mapped to a second codepoint of the one or more codepoints.

Aspect 39 is the first network entity of any of aspects 31-37, where, in accordance with the descending order, a first TAG of the subset of TAGs having a highest TAG ID is mapped to a first codepoint of the one or more codepoints and a second TAG of the subset of TAGs having a second highest TAG ID is mapped to a second codepoint of the one or more codepoints.

Aspect 40 is the first network entity of any of aspects 31-39, where the set of TAGs includes a primary TAG associated with a primary cell, and where a TAG identifier (ID) associated with the primary TAG is zero.

Aspect 41 is a first network entity for wireless communication, including: a memory; and at least one processor coupled to the memory, where the at least one processor is configured to: transmit, for a second network entity, a configuration of a set of timing advance groups (TAGs); transmit an activation of a subset of TAGs of the set of TAGs via a medium access control (MAC) control element (MAC-CE) or downlink control information (DCI), where the MAC-CE or the DCI is associated with one or more codepoints, and where each codepoint of the one or more codepoints is mapped to a respective TAG identifier (ID) associated with a respective TAG of the subset of TAGs according to a mapping; and communicate with the second network entity based on the subset of TAGs.

Aspect 42 is the first network entity of aspect 41, where the mapping is an ascending order or a descending order.

Aspect 43 is the first network entity of any of aspects 41-42, where, in accordance with the ascending order, a first TAG of the subset of TAGs having a lowest TAG ID is mapped to a first codepoint of the one or more codepoints and a second TAG of the subset of TAGs having a second lowest TAG ID is mapped to a second codepoint of the one or more codepoints.

Aspect 44 is the first network entity of any of aspects 41-42, where, in accordance with the descending order, a first TAG of the subset of TAGs having a highest TAG

ID is mapped to a first codepoint of the one or more codepoints and a second TAG of the subset of TAGs having a second highest TAG ID is mapped to a second codepoint of the one or more codepoints.

Aspect 45 is the first network entity of any of aspects 41-44, where the at least one processor is configured to: receive capability information indicative of at least one quantity of TAGs supported by the second network entity, where the configuration of the set of TAGs is based on the capability information.

Aspect 46 is the first network entity of any of aspects 41-45, where the at least one quantity of TAGs includes at least one maximum quantity of configured TAGs, and where each respective maximum quantity of the at least one maximum quantity of configured TAGs is associated with one of: each band of a group of bands associated with the second network entity, each subset of bands of one or more subsets of the group of bands, each feature set of one or more feature sets associated with the second network entity, or each component carrier of a set of component carriers associated with the second network entity.

Aspect 47 is the first network entity of any of aspects 41-46, where to transmit the configuration of the set of TAGs, the at least one processor is configured to transmit the configuration of the set of TAGs via radio resource control (RRC) signaling, where a first quantity of the set of TAGs is less than or equal to N, where N is a positive integer based on the at least one maximum quantity of configured TAGs.

Aspect 48 is the first network entity of any of aspects 41-47, where the at least one quantity of TAGs includes at least one maximum quantity of active TAGs, and where each respective maximum quantity of the at least one maximum quantity of configured TAGs is associated with one of: each band of the group of bands associated with the second network entity, each subset of bands of the one or more subsets of the group of bands, each feature set of the one or more feature sets associated with the second network entity, or each component carrier of the set of component carriers associated with the second network entity.

Aspect 49 is the first network entity of any of aspects 41-48, where a second quantity of the subset of TAGs is M, where M is less than or equal to N.

Aspect 50 is the first network entity of any of aspects 41-49, where the set of TAGs includes a primary TAG associated with a primary cell, and where a TAG ID associated with the primary TAG is zero.

Aspect 51 is a first network entity for wireless communication, including: a memory; and at least one processor coupled to the memory, where the at least one processor is configured to: receive, from a second network entity, a configuration of a set of timing advance groups (TAGs), where the set of TAGs includes a primary TAG associated with a primary cell, and where a TAG identifier (ID) associated with the primary TAG is zero; receive an activation of a subset of TAGs of the set of TAGs via a medium access control (MAC) control element (MAC-CE) or downlink control information (DCI); and communicate with the second network entity based on the subset of TAGs.

Aspect 52 is the first network entity of aspect 51, where the MAC-CE or the DCI is associated with one or more codepoints, where each codepoint of the one or more codepoints is mapped to a respective TAG ID associated with a respective TAG of the subset of TAGs according to a mapping.

Aspect 53 is the first network entity of any of aspects 51-52, where the mapping is an ascending order or a descending order.

Aspect 54 is the first network entity of any of aspects 51-53, where, in accordance with the ascending order, a first TAG of the subset of TAGs having a lowest TAG ID is mapped to a first codepoint of the one or more codepoints and a second TAG of the subset of TAGs having a second lowest TAG ID is mapped to a second codepoint of the one or more codepoints.

Aspect 55 is the first network entity of any of aspects 51-53, where, in accordance with the descending order, a first TAG of the subset of TAGs having a highest TAG ID is mapped to a first codepoint of the one or more codepoints and a second TAG of the subset of TAGs having a second highest TAG ID is mapped to a second codepoint of the one or more codepoints.

Aspect 56 is the first network entity of any of aspects 51-55, where the at least one processor is configured to: receive capability information indicative of at least one quantity of TAGs supported by the second first network entity, where the configuration of the set of TAGs is based on the capability information.

Aspect 57 is the first network entity of any of aspects 51-56, where the at least one quantity of TAGs includes at least one maximum quantity of configured TAGs, and where each respective maximum quantity of the at least one maximum quantity of configured TAGs is associated with one of: each band of a group of bands associated with the second network entity, each subset of bands of one or more subsets of the group of bands, each feature set of one or more feature sets associated with the second network entity, or each component carrier of a set of component carriers associated with the second network entity.

Aspect 58 is the first network entity of any of aspects 51-57, where to transmit the configuration of the set of TAGs, the at least one processor is configured to transmit the configuration of the set of TAGs via radio resource control (RRC) signaling, where a first quantity of the set of TAGs is less than or equal to N, where N is a positive integer based on the at least one maximum quantity of configured TAGs.

Aspect 59 is the first network entity of any of aspects 51-58, where the at least one quantity of TAGs includes at least one maximum quantity of active TAGs, and where each respective maximum quantity of the at least one maximum quantity of configured TAGs is associated with one of: each band of the group of bands associated with the second network entity, each subset of bands of the one or more subsets of the group of bands, each feature set of the one or more feature sets associated with the second network entity, or each component carrier of the set of component carriers associated with the second network entity.

Aspect 60 is the first network entity of any of aspects 51-59, where a second quantity of the subset of TAGs is M, where M is less than or equal to N.

Aspect 61 is a method of wireless communication for implementing any of aspects 1 to 30.

Aspect 62 is an apparatus for wireless communication including means for implementing any of aspects 1 to 30.

Aspect 63 is a computer-readable medium (e.g., a non-transitory computer-readable storage medium) storing computer executable code, where the code when executed by a processor causes the processor to implement any of aspects 1 to 30.

Aspect 64 is a method of wireless communication for implementing any of aspects 31 to 60.

Aspect 65 is an apparatus for wireless communication including means for implementing any of aspects 31 to 60.

Aspect 66 is a computer-readable medium (e.g., a non-transitory computer-readable storage medium) storing computer executable code, where the code when executed by a processor causes the processor to implement any of aspects 31 to 60.

1. A first network entity for wireless communication, comprising:
a memory; and
at least one processor coupled to the memory, wherein the at least one processor is configured to:
transmit, to a second network entity, capability information indicative of at least one quantity of timing advance groups (TAGs) supported by the first network entity; and
receive, from the second network entity, a configuration of a set of TAGs based on the capability information.

2. The first network entity of claim 1, wherein the at least one quantity of TAGs comprises at least one maximum quantity of configured TAGs, and wherein each respective maximum quantity of the at least one maximum quantity of configured TAGs is associated with one of:
each band of a group of bands associated with the first network entity,
each subset of bands of one or more subsets of the group of bands,
each feature set of one or more feature sets associated with the first network entity, or
each component carrier of a set of component carriers associated with the first network entity.

3. The first network entity of claim 2, wherein to receive the configuration of the set of TAGs, the at least one processor is configured to receive the configuration of the set of TAGs via radio resource control (RRC) signaling, wherein a first quantity of the set of TAGs is less than or equal to N, where N is a positive integer based on the at least one maximum quantity of configured TAGs.

4. The first network entity of claim 3, wherein the at least one quantity of TAGs comprises at least one maximum quantity of active TAGs, and wherein each respective maximum quantity of the at least one maximum quantity of active TAGs is associated with one of:
each band of the group of bands associated with the first network entity,
each subset of bands of the one or more subsets of the group of bands,
each feature set of the one or more feature sets associated with the first network entity, or
each component carrier of the set of component carriers associated with the first network entity.

5. The first network entity of claim 4, wherein the at least one processor is configured to receive an activation of a subset of TAGs of the set of TAGs via a medium access control (MAC) control element (MAC-CE) or downlink control information (DCI), and wherein a second quantity of the subset of TAGs is M, where M is less than or equal to N.

6. The first network entity of claim 5, wherein the MAC-CE or the DCI is associated with one or more codepoints, and wherein each codepoint of the one or more codepoints is mapped to a respective TAG identifier (ID) associated with a respective TAG of the subset of TAGs according to a mapping.

7. The first network entity of claim 6, wherein the mapping is an ascending order or a descending order.

8. The first network entity of claim 7, wherein, in accordance with the ascending order, a first TAG of the subset of TAGs having a lowest TAG ID is mapped to a first codepoint of the one or more codepoints and a second TAG of the subset of TAGs having a second lowest TAG ID is mapped to a second codepoint of the one or more codepoints.

9. The first network entity of claim 7, wherein, in accordance with the descending order, a first TAG of the subset of TAGs having a highest TAG ID is mapped to a first codepoint of the one or more codepoints and a second TAG of the subset of TAGs having a second highest TAG ID is mapped to a second codepoint of the one or more codepoints.

10. The first network entity of claim 1, wherein the set of TAGs comprises a primary TAG associated with a primary cell, and wherein a TAG identifier (ID) associated with the primary TAG is zero.

11. A first network entity for wireless communication, comprising:
a memory; and
at least one processor coupled to the memory, wherein the at least one processor is configured to:
receive, from a second network entity, a configuration of a set of timing advance groups (TAGs);
receive an activation of a subset of TAGs of the set of TAGs via a medium access control (MAC) control element (MAC-CE) or downlink control information (DCI), wherein the MAC-CE or the DCI is associated with one or more codepoints, and wherein each codepoint of the one or more codepoints is mapped to a respective TAG identifier (ID) associated with a respective TAG of the subset of TAGs according to a mapping; and
communicate with the second network entity based on the subset of TAGs.

12. The first network entity of claim 11, wherein the mapping is an ascending order or a descending order.

13. The first network entity of claim 12, wherein, in accordance with the ascending order, a first TAG of the subset of TAGs having a lowest TAG ID is mapped to a first codepoint of the one or more codepoints and a second TAG of the subset of TAGs having a second lowest TAG ID is mapped to a second codepoint of the one or more codepoints.

14. The first network entity of claim 12, wherein, in accordance with the descending order, a first TAG of the subset of TAGs having a highest TAG ID is mapped to a first codepoint of the one or more codepoints and a second TAG of the subset of TAGs having a second highest TAG ID is mapped to a second codepoint of the one or more codepoints.

15. The first network entity of claim 11, wherein the at least one processor is configured to:
transmit, to the second network entity, capability information indicative of at least one quantity of TAGs supported by the first network entity,
wherein the configuration of the set of TAGs is based on the capability information.

16. The first network entity of claim 15, wherein the at least one quantity of TAGs comprises at least one maximum quantity of configured TAGs, and wherein each respective maximum quantity of the at least one maximum quantity of configured TAGs is associated with one of:
each band of a group of bands associated with the first network entity,
each subset of bands of one or more subsets of the group of bands,
each feature set of one or more feature sets associated with the first network entity, or each component carrier of a set of component carriers associated with the first network entity.

17. The first network entity of claim 16, wherein to receive the configuration of the set of TAGs, the at least one processor is configured to receive the configuration of the set of TAGs via radio resource control (RRC) signaling, wherein a first quantity of the set of TAGs is less than or equal to N, where N is a positive integer based on the at least one maximum quantity of configured TAGs.

18. The first network entity of claim 16, wherein the at least one quantity of TAGs comprises at least one maximum quantity of active TAGs, and wherein each respective maximum quantity of the at least one maximum quantity of active TAGs is associated with one of:
each band of the group of bands associated with the first network entity,
each subset of bands of the one or more subsets of the group of bands,
each feature set of the one or more feature sets associated with the first network entity, or
each component carrier of the set of component carriers associated with the first network entity.

19. The first network entity of claim 18, wherein a second quantity of the subset of TAGs is M, where M is less than or equal to N.

20. The first network entity of claim 11, wherein the set of TAGs comprises a primary TAG associated with a primary cell, and wherein a TAG ID associated with the primary TAG is zero.

21-30. (canceled)
